(19) United States
(12) Patent Application Publication
(10) Pub. No.: US 2025/0217712 A1
(43) Pub. Date: Jul. 3, 2025

(54) SYSTEMS AND METHODS FOR DETECTING PREJUDICE BIAS IN MACHINE-LEARNING MODELS

(71) Applicant: OneTrust, LLC, Atlanta, GA (US)

(72) Inventors: Jonathan Blake Brannon, Smyrna, GA (US); Ashok Kallarakuzhi, Atlanta, GA (US); Evan Bates, Atlanta, GA (US); Saravanan Pitchaimani, Atlanta, GA (US); Vivek Srivastava, Atlanta, GA (US)

(21) Appl. No.: 19/082,005

(22) Filed: Mar. 17, 2025

Related U.S. Application Data
(63) Continuation of application No. 17/494,220, filed on Oct. 5, 2021, now Pat. No. 12,265,896.
(60) Provisional application No. 63/087,443, filed on Oct. 5, 2020.

(51) Int. Cl. G06N 20/00

(52) U.S. Cl. CPC G06N 20/00

(57) ABSTRACT

Aspects of the present invention provide methods, apparatuses, systems, computing devices, computing entities, and/or the like for detecting prejudice bias in machine-learning models and/or data sets used in training, testing, and/or validating the models. In accordance various aspects, a method is provided comprising: receiving a data set used for training, testing, and/or validating a model that comprises data instances; generating, using a classification model, a prediction of applicability for each sub-category of a plurality of sub-categories for each bias category of a plurality of bias categories for each data instance; determining that a particular sub-category for a particular bias category is applicable to a proportion of the data set, wherein predictions of applicability for the particular sub-category generated for the proportion of the data set satisfies a threshold; and determining, based on the proportion, that the data set has a prejudice bias with respect to the particular bias category.

### CROSS-REFERENCE TO RELATED APPLICATIONS

This application is a continuation of U.S. patent application Ser. No. 17/494,220, filed on Oct. 5, 2021, which claims the benefit of U.S. Provisional Patent Application Ser. No. 63/087,443, filed Oct. 5, 2020. which is hereby incorporated herein by reference in its entirety.

### TECHNICAL FIELD

The present disclosure is generally related to a computing system used for detecting prejudice bias in machine-learning models and/or data sets used in training, testing, and/or validating the models.

### BACKGROUND

Bias introduced into machine learning (ML) can lead to the production of algorithms that produce results that are inaccurate (and can therefore be unsuitable for their intended purpose). Such bias in machine-learning models can have significant consequences when used in artificial intelligence (AI) applications that may produce such inaccurate results, such as causing computing systems, devices, or other systems that rely on ML outputs to function incorrect.

### SUMMARY

In general, various aspects of the present invention provide methods, apparatuses, systems, computing devices, computing entities, and/or the like for detecting prejudice bias in machine-learning models and/or data sets used in training, testing, and/or validating the models. In accordance various aspects, a method is provided. According, the method comprises: receiving a data set used for at least one of training, testing, or validating a machine-learning model, wherein the data set comprises a plurality of data instances; generating, by computing hardware and with a classification model, a prediction of applicability for each sub-category of a plurality of sub-categories for each bias category of a plurality of bias categories for each data instance of the plurality of data instances, wherein (a) the classification model comprises an ensemble comprising a multi-label classifier for each bias category of the plurality of bias categories, and (b) each multi-label classifier is configured to generate the prediction of applicability for each sub-category of the plurality of sub-categories for a corresponding bias category of the plurality of bias categories; determining, by the computing hardware, that a particular sub-category of the plurality of sub-categories for a particular bias category of the plurality of bias categories is applicable to a proportion of the data set, wherein predictions of applicability for the particular sub-category generated for the proportion of the data set satisfies a threshold; determining, by the computing hardware based on the proportion, that the data set has a prejudice bias with respect to the particular bias category; and causing, by the computing hardware, performance of an action based on the prejudice bias.

According to some aspects, the particular bias category comprises at least one of religion, sexual orientation, age, ethnicity, gender, location, or political opinions. According to some aspects, determining the data set has the prejudice bias comprises determining that the proportion of the data set satisfies a threshold. According to some aspects, the action may comprise generating a notification indicating the prejudice bias that is communicated to an individual. According to other aspects, the action may comprise identifying a recommendation comprising at least one of an addition or removal of a plurality of data instances applicable to the particular sub-category to make to the data set and providing the recommendation through a notification communicated to an individual. According to other aspects, the action may comprise modifying the data set by performing at least one of adding or removing a plurality of data instances applicable to the particular sub-category.

According to particular aspects, the method may further comprise generating, by computing hardware and with the classification model, a prediction of applicability for each sub-category of the plurality of sub-categories for each bias category of the plurality of bias categories for each data instance of a plurality of data instances found in the modified data set; and determining, by the computing hardware based on the prediction of applicability generated for each sub-category of the plurality of sub-categories for each bias category of the plurality of bias categories for each data instance, that the data set does not have a prejudice bias. According to some aspects, the proportion of the data set is associated with a location. Here, the method may further comprise mapping, by the computing hardware based on the location, the prejudice bias to a factor influencing a risk associated with the data set having the prejudice bias and determining, by the computing hardware based on the factor, the risk associated with the data set having the prejudice bias.

In accordance with various aspects, a system is provided comprising a non-transitory computer-readable medium storing instructions and a processing device communicatively coupled to the non-transitory computer-readable medium. Accordingly, the processing device is configured to execute the instructions and thereby perform operations comprising: processing a known data set using a machine-learning model to generate a plurality of outputs, wherein the known data set comprises a plurality of data instances associated with a plurality of sub-categories for each bias category in a plurality of bias categories in proportions to sufficiently represent each sub-category of the plurality of sub-categories for each bias category in the plurality of bias categories and a plurality of result instances comprises each data instance of the plurality of data instances and corresponding output in the plurality of outputs; generating, using a classification model, a prediction of applicability for each sub-category of the plurality of sub-categories for each bias category of the plurality of bias categories for each result instance of the plurality of result instances, wherein the classification model comprises an ensemble comprising a multi-label classifier for each bias category of the plurality of bias categories, each multi-label classifier is configured to generate the prediction of applicability for each sub-category of the plurality of sub-categories for the corresponding bias category of the plurality of bias categories; determining that a particular sub-category of the plurality of sub-categories for a particular bias category of the plurality of bias categories is applicable to a proportion of the plurality of result instances, wherein the prediction of applicability for the particular sub-category for each applicable output instance found in the proportion of the plurality of result instances satisfies a threshold; determining, based on the proportion, that the machine-learning model has a prejudice bias with respect to the particular bias category; and causing performance of an action based on the prejudice bias.

According to some aspects, the particular bias category comprises at least one of religion, sexual orientation, age, ethnicity, gender, location, or political opinions. According to some aspects, the action may comprise generating a notification indicating the prejudice bias that is communicated to an individual. According to other aspects, the action may comprise providing an interface to an analytics tool that can be used in identifying a component of the machine-learning model influencing the machine-learning model having the prejudice bias.

According to particular aspects, determining the machine-learning model as having the prejudice bias comprises at least one of determining the proportion of the plurality of result instances is less than a threshold and the prejudice bias indicates the particular sub-category is underrepresented in the plurality of result instances or determining the proportion of the plurality of result instances is greater than a threshold and the prejudice bias indicates the particular sub-category is overrepresented in the plurality of result instances. According to other aspects, determining the machine-learning model has the prejudice bias comprises determining the proportion of the plurality of result instances comprises a number of result instances that are falsely applicable to the particular sub-category satisfies a threshold.

According to some aspects, the proportion of the plurality of result instances is associated with a location. Here, the operations may further comprise mapping, based on the location, the prejudice bias to a factor influencing a risk associated with the machine-learning model having the prejudice bias and determining, based on the factor, the risk associated with the machine-learning model having the prejudice bias.

In accordance with yet various aspects, a system is provided. According to particular aspects, the system comprises first computing hardware configured for: accessing a data set used for at least one of training, testing, or validating a machine-learning model, wherein the data set comprises a plurality of data instances; generating, by using a classification model, a prediction of applicability of a sub-category of a plurality of sub-categories for a bias category of a plurality of bias categories for each data instance of the plurality of data instances, wherein the classification model comprises an ensemble comprising a multi-label classifier for each bias category of the plurality of bias categories, each multi-label classifier is configured to generate the prediction of applicability for each sub-category of the plurality of sub-categories for the corresponding bias category of the plurality of bias categories, determining that a particular sub-category of the plurality of sub-categories for a particular bias category of the plurality of bias categories is applicable to a proportion of the data set, wherein the prediction of applicability for the particular sub-category for each applicable data instance found in the proportion of the data set satisfies a threshold, and determining, based on the proportion, that the data set has a prejudice bias with respect to the particular bias category.

According to particular aspects, the system further comprises second computing hardware communicatively coupled to the first computing hardware and configured for modifying the data set subsequent to the first computing hardware determining that the data set has the prejudice bias. According to some aspects, modifying the data set comprises performing at least one of adding or removing a plurality of data instances applicable to the particular sub-category.

According to particular aspects, the first computing hardware is further configured for generating a notification indicating the prejudice bias that is communicated to an individual and transmitting the notification to the second computing hardware. According to particular aspects, the first computing hardware is further configured for identifying a recommendation comprising at least one of an addition or a removal of a plurality of data instances applicable to the particular sub-category to make to the data set and providing the recommendation through a notification communicated to an individual.

According to some aspects, the proportion of the data set is associated with a location. Here, the operations may further comprise mapping, based on the location, the prejudice bias to a factor influencing a risk associated with the data set having the prejudice bias and determining, based on the factor, the risk associated with the data set having the prejudice bias.

### BRIEF DESCRIPTION OF THE DRAWINGS

In the course of this description, reference will be made to the accompanying drawings, which are not necessarily drawn to scale, and wherein:

FIG. 1 provides an overview of a process that can be used for detecting prejudice bias in machine-learning models and/or data sets used in training, testing, and/or validating the models in accordance with various aspects of the present disclosure;

FIG. 2 depicts an example of a computing environment that can be used for detecting prejudice bias in machine-learning models and/or data sets used in training, testing, and/or validating the models in accordance with various aspects of the present disclosure;

FIG. 3 is a flowchart of a process for detecting prejudice bias in a data set that can be used for training, testing, and/or validating a machine-learning model in accordance with various aspects of the present disclosure;

FIG. 4 is a flowchart of a process for detecting prejudice bias in a machine-learning model in accordance with various aspects of the present disclosure;

FIG. 5 is a flowchart of a process for determining a risk associated with a prejudice bias identified for a data set or a machine-learning model in accordance with various aspects of the present disclosure;

FIG. 6 is a block diagram illustrating a system architecture that may be used in accordance with various aspects of the present disclosure; and

FIG. 7 is a schematic diagram of computing entity that may be used in accordance with various aspects of the present disclosure.

### DETAILED DESCRIPTION

Various aspects for practicing the technologies disclosed herein are described more fully hereinafter with reference to the accompanying drawings, in which some, but not all aspects of the technologies disclosed are shown. Indeed, various aspects disclosed herein are provided so that this disclosure will satisfy applicable legal requirements and should not be construed as limiting or precluding other aspects applying the teachings and concepts disclosed herein. Like numbers in the drawings refer to like elements throughout.

### Overview and Technical Contributions of Various Aspects

Many software applications, especially software applications used in artificial intelligence (AI), rely on machine-learning techniques in performing various tasks. For instance, many companies have incorporated AI applications to interface with customers or other users in a variety of ways. For example, an organization may provide AI functionality on its website through the use of machine learning to conduct online chat sessions with customers visiting the website to purchase a product. Here, a machine learning technique may be used in generating responses (e.g., predicting responses) to answer questions asked by customers through the chat sessions to mimic agents (e.g., humans) conducting the chats with the customers. Therefore, machine learning techniques are often used in automating tasks that are normally carried out by humans. This can be true, not only for software applications, but also in automating tasks for various hardware operations and/or other computational processes.

However, an improperly trained and/or configured machine learning model can lead to errors in the performance of a software application, hardware operation, computational process, and/or the like using the machine learning model. For example, an improperly trained and/or configured machine-learning model can lead to the model generating incorrect and/or inaccurate results (output) that are then applied by a software application, resulting in the software application not functioning in the manner intended.

A common source of error that is encountered in machine learning, especially machine learning used in applications involving data associated with humans such as facial recognition, voice recognition, text recognition, and/or the like, is prejudice bias. Prejudice bias exists in a machine-learning model when the model produces results that reflect existing prejudices, stereotypes, faulty societal assumptions, and/or the like. Accordingly, an application's use of the results having prejudice bias can lead to the application not operating appropriately (e.g., fairly) for each group of individuals (e.g., races, genders, backgrounds, cultures, and/or the like) that use the application. Prejudice bias can be introduced in a machine-learning model when the data used for training, testing, and/or validating the machine-learning model reflects these existing prejudices, stereotypes, and/or faulty societal assumptions. Further, prejudice bias can be introduced in a machine-learning model when the model is configured in manner that reflects these existing prejudices, stereotypes, and/or faulty societal assumptions.

Accordingly, various aspects of the disclosure address several of the technical challenges associated with detecting prejudice bias in machine-learning models and/or data sets used in training, testing, and/or validating the models. Specifically, various aspects of the disclosure provide a bias evaluation process configured to perform an analysis on the machine-learning models and/or data sets used for training, testing, and/or validating machine-learning models to identity prejudice bias found within the data sets and/or machine-learning models.

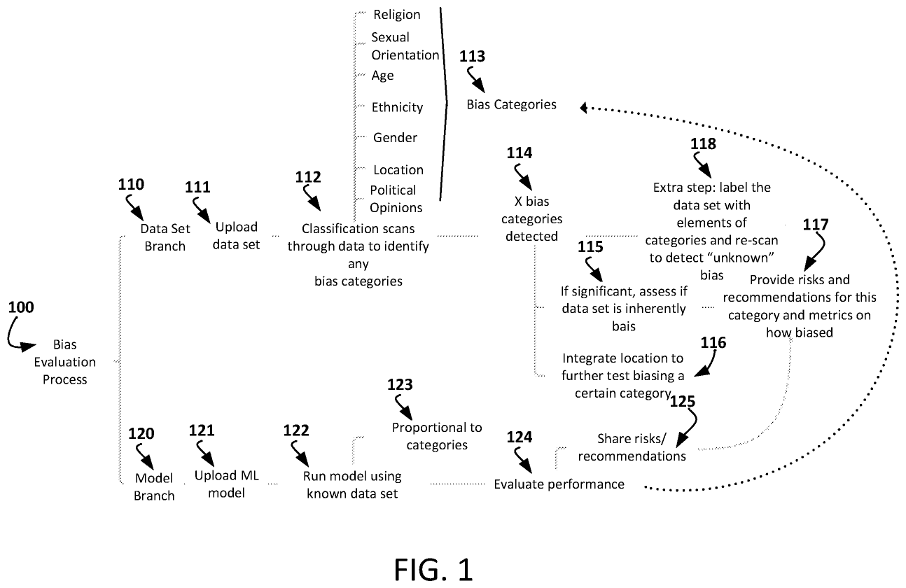

Turning now to FIG. 1, an overview of a bias evaluation process 100 is provided in accordance with various aspects of the present disclosure. Here, the bias evaluation process 100 may be configured with two branches. The first branch (data set branch 110) is used in analyzing a data set for prejudice bias. The second branch (model branch 120) is used in analyzing a machine-learning model for prejudice bias.

Referring now to the data set branch 110, a data set can be uploaded 111 into a bias evaluation system to be analyzed (as further detailed herein). For instance, an individual (e.g., a developer) may upload the data set into the bias evaluation system through a portal or interface provided for the system. Once the data set is uploaded, the bias evaluation system processes the data set using a classification engine to scan through the data found in the data set to identify any bias categories that may exist in the data set 112. According to various aspects, the classification engine may initially assign one or more classes for various categories to particular data instances found in the data set. For example, a data instance may comprise a set of data, such as a data record found in the data set, that provides an input and an output used for training, testing, and/or validating a machine-learning model. Therefore, the classification engine may process each data instance to assign one or more classes for various categories to the records.

Many applications that use machine-learning models will process sensitive data such as personal data of individuals. For example, many AI applications may collect personal data from an individual through technologies such as speech recognition and/or image recognition and then process the personal data using a machine-learning model to perform a task. Personal data may include, but is not limited to, personally identifiable information (PII), which may be information that directly (or indirectly) identifies an individual or entity. Examples of PII include names, addresses, dates of birth, social security numbers, and biometric identifiers such as a person's fingerprints or picture. Other personal data may include, for example, individuals' Internet browsing habits, purchase history, or even their preferences (e.g., likes and dislikes, such as provided or obtained through social media). Some personal data may include demographic or other sensitive information (e.g., religion, race, ethnicity, gender, sexual preference, political affiliation, etc.).

Therefore, data sets used in training, testing, and/or validating machine-learning models that are used in applications that process personal data will include the personal data in the data instances found in the data set so that the machine-learning models can be developed accordingly for different groups of individuals. However, when a data set is not constructed in a manner to include personal data to adequately represent relevant groups of individuals (e.g., different races, genders, backgrounds, cultures, and/or the like), then the data set can introduce bias into a machine-learning model that is trained, tested, and/or validated using the data set.

According to various aspects, the classification engine can identify particular categories that may introduce bias into the data set. For example, the bias categories 113 may include religion, sexual orientation, age, ethnicity, gender, location, political opinions, and/or the like. Different sub-categories may be found within each of the categories. For example, the gender category may include the sub-categories male and female. The ethnicity category may include the sub-categories Asian, Black, Hispanic, White, and/or the like. At this point, the bias evaluation system analyzes the different categories 113 identified as represented in the data set to detect 114 whether the data set may be bias with respect to any of the identified categories 113. As detailed further herein, the bias evaluation system may perform this analysis by determining whether any of the identified categories 113 for the data set have a significant impact on the data set. For instance, the bias evaluation system may make a determination as to whether a proportion of the data set (e.g., a number of data instances) that represents any particular sub-category within a category satisfies a threshold amount or percentage of the part of the data set (e.g., number of data instances found in the data set) that represents the entire category. For example, the bias evaluation system may make a determination as to whether a proportion of the data set representing males satisfies a threshold amount or percentage of the part of the data set representing the category gender. If any category has a significant impact on the data set, then the system may be further used in assessing the data set to determine whether the data set is inherently biased 115.

In some instances, a factor, attribute, characteristic, and/or the like may be used in the analysis. For example, location can be integrated into the analysis to further test whether the data set is biasing a certain category 116. Finally, if any particular categories are having a significant impact on the data set, then the bias evaluation system, according to various aspects, indicates the risks of such prejudice bias and provides recommendations to the individual 117. According to some aspects, the individual may label the data set with the sub-categories found in the categorizes and re-scan the data set to detect any previously undetected prejudice bias 118.

Referring now to the model branch 120 of the bias evaluation process 100, instead of, or in addition to, uploading a data set, an individual (e.g., a developer) may upload a machine-learning model to the bias evaluation system to be analyzed 121. The bias evaluation system, according to various aspects, processes a “known” data set using the machine-learning model to determine whether the model may be introducing bias in the output produced by the model 122. The known data set includes data instances that are known be associated with certain bias categories (e.g., religion, sexual orientation, age, ethnicity, gender, location, political opinions, and/or the like). For example, the known data set may include data instances having personal data known to be related to certain bias categories. Here, the known data set includes proportional data 123 (e.g., a proportional number of data instances) that sufficiently represents each of the different sub-categories found in each of the categories so as to not introduce bias into the output produced by the machine-learning model. Therefore, any bias introduced into the output of the machine-learning model is the result of the model itself (e.g., the configuration of the model may be activating or otherwise operating in a manner the introduces bias into the output of the model).

Here, the bias evaluation system can analyze the results from processing the known data set using the machine-learning model to evaluate the performance of the model 124. Here, a “result instance” may be viewed as a combination of a data instance found in the known data set and the data instance's corresponding output produced by the machine learning model. Specifically, according to particular aspects, the bias evaluation system can use the classification engine in analyzing the results from the machine-learning model to assign one or more sub-categories of the different categories to the result instances. The bias evaluation system can then determine whether any of the categories associated with the known data set are having a significant impact on the output. For example, a determination may be made as to whether a proportion of the output (e.g., number of output instances) that represents any particular sub-category of a category satisfies a threshold amount or percentage of the part of the results (e.g., number of result instances found in the results) that represents the entire category. In another example, a determination may be made as to whether the machine learning module is generating erroneous output providing false indications of any particular sub-category of a category.

If any particular categories are having a significant impact on the results of the machine-learning model, then the bias evaluation system can indicate the risks of such prejudice bias and share risks and/or recommendations to the individual 125. Accordingly, the individual may then assess the machine-learning model to determine whether the model is inherently biased. For example, according to particular aspects, the bias evaluation system may provide the individual with one or more analytic tools, such as the Language Interpretability Tool (LIT) and/or What-If-Tool (WIT) provided by Google, that can be used in assessing the machine-learning model to determine what may be causing the bias.

Accordingly, various aspects of the disclosure provided herein address many of the technical disadvantages encountered in identifying prejudice bias that may be introduced into machine-learning models via data sets used in training, testing, and/or validating the models, as well as the configuration of the models themselves. Specifically, various aspects of the disclosure provide a novel system that can be used for analyzing and evaluating data sets that are used in training, testing, and/or validating machine-learning models to determine whether the data sets introduce any prejudice bias into the machine-learning models. In addition, various aspects of the disclosure provide a novel system that can be used for analyzing and evaluating machine-learning models using known data sets to determine whether the models, themselves, introduce prejudice bias. As a result, various aspects of the disclosure can assist developers of machine-learning models in developing machine-learning models that can be used in many different AI applications that minimize or eliminate bias. In doing so, various aspects of the present disclosure make major technical contributions to improving the use, fairness, and effectiveness of machine learning in various AI applications.

### Example Computing Environment

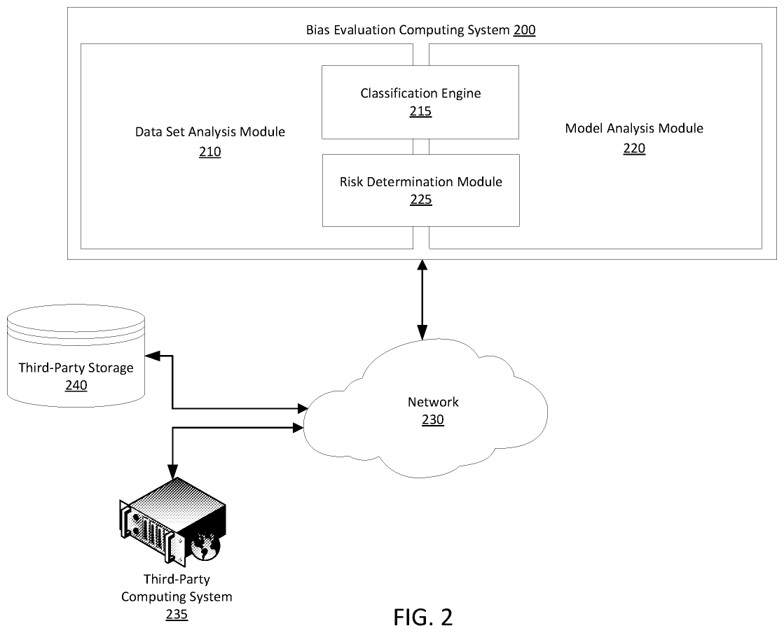

Referring now to the figures, FIG. 2 depicts an example of a computing environment that can be used for detecting prejudice bias in machine-learning models and/or data sets used in training, testing, and/or validating the models according to various aspects. For example, the machine-learning models and/or data sets that are to be analyzed may be created, developed, maintained, used, and/or the like by one or more third-party developers, may be provided by one or more AI application provider servers or other systems, and/or may be installed on one or more remote systems for use. Accordingly, an entity (e.g., organization) associated with a particular machine-learning model may be interested in understanding whether the particular machine-learning model introduces bias that may include, for example, existing prejudices, stereotypes, and/or faulty societal assumptions into an application in which the machine-learning model is being used. In addition, or instead, the entity may be interested in understanding whether a data set used in training a machine-learning model may be introducing such bias into the machine-learning model.

Accordingly, a bias evaluation computing system 200 may be provided that includes software components, hardware components, or both for analyzing and evaluating machine-learning models and/or data sets used in training, testing, and/or validating machine-learning models for prejudice bias represented in the machine-learning models and/or data sets. For example, the bias evaluation computing system 200 can retrieve or otherwise access the machine-learning model and/or data set over a network 230 (e.g., the Internet) from a third-party computing system 235 and/or a third-party data storage 240 associated with the entity. The third-party data storage 240 may reside within the third-party computing system 235 or externally, as shown in FIG. 2.

According to various aspects of the disclosure, the bias evaluation computing system 200 may comprise computing hardware performing a number of different processes in conducting the analysis and evaluation of the machine-learning model and/or data set. Specifically, according to particular aspects, the bias evaluation computing system 200 executes a data set analysis module 210 in analyzing and evaluating a data set in identifying any prejudice bias in the data set.

As further detailed herein, the data set analysis module 210 can determine one or more sub-categories of bias categories that are applicable to data instances found in the data set. According to particular aspects, the data set analysis module 210 uses a classification engine 215 in determining the sub-categories for the bias categories that are applicable to the data instances found in the data set. The classification engine 215 includes program code that implements a machine-learning model in generating classifications (e.g., predictions) of sub-categories for the different bias categories that are applicable to the data instances found in the data set.

The data set analysis module 210 can also determine whether the data set may be potentially biased based on the particular sub-categories identified for the bias categories. If the data set is determined to have prejudice bias, then the data set analysis module 210 may provide the risks associated with the prejudice bias. According to particular aspects, the data set analysis module 210 may invoke a risk determination module 225 to determine the risks associated with a prejudice bias identified for the data set. In turn, the risk determination module 225 can map the prejudice bias to factors, attributes, characteristics, and/or the like that may influence the risk associated with the prejudice bias. The data set analysis module 210 can report the results of the analysis and evaluation. For example, the data set analysis module 210 may display the results on an interface and/or send one or more communications providing the results.

Similarly, the bias evaluation computing system 200 executes a model analysis module 220 in analyzing and evaluating a machine-learning model in identifying any prejudice bias in the model. As further detailed herein, the model analysis module 220 can process a known data set using the machine learning. The known data set includes data instances that are known to have data that is associated with certain bias categories (e.g., religion, sexual orientation, age, ethnicity, gender, location, political opinions, and/or the like) and can include proportional data that sufficiently represents each sub-category of the different categories so as to not introduce bias into the output produced by the machine-learning model. Therefore, any bias introduced into the output of the machine-learning model is the result of the model itself.

The model analysis module 220 analyzes the output from the machine-learning model to determine the sub-categories of the different bias categories represented in the output. Again, similar to the data set analysis module 210, the model analysis module 220 may use the classification engine 215 in determining the applicable sub-categories. The model analysis module 220 continues with determining whether the machine-learning model may be potentially biased based on the particular sub-categories identified for the bias categories. If the model is determined to have prejudice bias, then the model analysis module 220 may provide the risks associated with the prejudice bias. Similar to the data set analysis module 210, the model analysis module 220 may invoke a risk determination module 225 to determine the risks associated with a prejudice bias identified for the machine-learning model. The model analysis module 220 reports the results of the analysis and evaluation in a similar fashion as the data set analysis module 210. Further detail is now provided on the configuration and functionality of the different modules 210, 220, 225 according to various aspects of the disclosure.

### Data Set Analysis Module

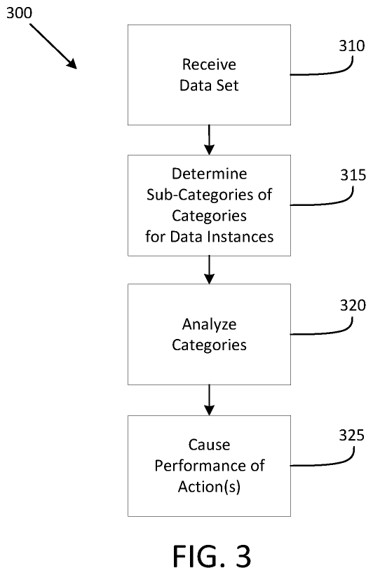

Turning now to FIG. 3, additional details are provided regarding a data set analysis module 210 for detecting prejudice bias in a data set that can be used for training, testing, and/or validating a machine-learning model in accordance with various aspects of the disclosure. For instance, the data set analysis module 210 is configured according to various aspects for performing the data set branch 110 of the bias evaluation process 100. Accordingly, the flow diagram shown in FIG. 3 may correspond to operations carried out, for example, by computing hardware found in the bias evaluation computing system 200 as described herein, as the computing hardware executes the data set analysis module 210.

The process 300 involves the data set analysis module 210 receiving a data set used for training, testing, and/or validating a machine-learning model that is to be analyzed for prejudice bias in Operation 310. As previously mentioned, the bias evaluation system 200 according to particular aspects may provide some type of mechanism such as an application programming interface (API), a Web portal, a user interface, and/or the like that can be used by an individual (e.g., a developer) to facilitate the uploading of the data set into the system 200. Once uploaded, the data set analysis module 210 may be invoked and receives the data set accordingly.

The data set analysis module 210 then determines one or more sub-categories of various categories that are applicable to data instances found in the data set in Operation 315. In various aspect, a data instance can be a group of data found in the data set that provides an input and/or output using in training, testing, and/or validating a machine-learning model. Here, the data set may be known to include certain types of data that are related to categories of interest (bias categories). For example, as previously noted, many applications that use machine-learning models will process sensitive data such as personal data of individuals. Therefore, the data set may be known to include personal data in the data instances found in the data set so that any machine-learning model developed using the data set can be developed for different sources that can potentially lead to prejudice bias (e.g., different races, genders, backgrounds, cultures, and/or the like). In addition, depending on the circumstances, a data instance may include text data, media data, numerical data, categorical data, the like, and/or any combination thereof. For example, text data may comprise a word, a phrase, a sentence, a paragraph, and/or the like. As another example, media data may comprise an image, a group of images, a recording, a video, and/or the like. Those of ordinary skill in the art can envision various types of data that may be found in the data instances that make up the data set in light of this disclosure.

According to various aspects, the data set analysis module 210 can determine one or more sub-categories of the various categories applicable to each data instance found in the data set by using a classification engine 215. The classification engine 215 identifies one or more sub-categories of various sources of prejudice bias (e.g., bias categories) that are applicable to each data instance. For example, the bias categories may include religion, sexual orientation, age, ethnicity, gender, location, political opinions, and/or the like. Within these bias categories, the sub-categories of “male” and “female” may be found in the bias category “gender,” the sub-categories of “Republican” and “Democrat” may be found in the bias category political opinions, etc. According to various aspects, the classification engine 215 identifies the one or more sub-categories found in the bias categories related to each data instance by processing the data instance (or suitable representation(s) thereof) using a classification model. According to various aspects, the classification model generates an output for a data instance identifying the sub-categories of the bias categories that may be associated with (i.e., relevant to) the data instance.

Here, according to particular aspects, the classification model may comprise an ensemble of multiple classifiers. For instance, the classification model may include a classifier for each bias category. For example, the classification model may include a first classifier for the bias category “ethnicity,” a second classifier for the bias category “gender,” a third classifier for the bias category “age,” and so forth. Each of the classifiers may be a multi-label classifier in which a prediction is provided for each sub-category of the bias category. The classification model may provide a data instance (e.g., different data elements that make up the data instance) from the data set as input to the classification model and the model may generate an output for the data instance that may comprise a representation (e.g., vector representation) that includes a component for each sub-category found in a bias category providing the prediction (e.g., value) on the applicability of the sub-category to the data instance. Furthermore, the representation may provide a confidence (e.g., confidence value) for each prediction on the applicability of the corresponding sub-category of the bias category.

According to some aspects, the classifier may be a Bidirectional Encoder Representations from Transformers (“BERT”) classifier. A fine-tuning process may be carried out for training the BERT classifier that involves using training data sets having attributes that recur across one or more industries to train the classifier for a corresponding classification task. The classification task could include classifying a data instance as belonging to one or more of the different sub-categories found in a particular bias category. As an illustrative example, many credit reporting agencies may use certain common attributes for generating credit scores such as income level, physical address, late payments, and/or the like. In this example, a training data set may be constructed to include those attributes. The training data set would also include ground-truth data identifying which data instances belong to certain bias categories and/or sub-categories The data analysis module 210 (or other suitable program code executed by the bias evaluation computing system 200) performs a fine-tuning process for the BERT classifier using the training data set. For instance, the fine-tuning process could involve adding one or more layers to the BERT classifier that are configured to classify data instances having those attributes according to a particular bias category. The fine-tuning process further involves modifying one or more parameters of the BERT classifier having the added set of layers, thereby minimizing, or otherwise reducing the error between the ground-truth data and the outputs of the BERT classifier.

Additionally or alternatively, the BERT model could be fine-tuned with a training data set having attributes specific to a certain entity who is interested in having a particular data set analyzed. For instance, if the entity is a credit agency, but uses different attributes to compute a credit score than is typical in the industry, then the BERT classifier could be fine-tuned on a training data set specific to those attributes. Here, for example, the third party may provide the training data set having those attributes along with ground-truth data identifying a data instance as having certain values for attributes 1-n actually belong to particular sub-categories found within a bias category.

Therefore, according to various aspects, the classification engine 215 may use a particular classification model based on an association related to the data set being analyzed. For example, the classification engine 215 may use a first classification model developed for a first industry in analyzing a data set associated with a first entity who operates in the first industry and use a second, different classification model developed for a second industry in analyzing a data set associated with a second, different entity who operates in the second industry. Likewise, the classification engine 215 may use a particular classification model based on the type of data (e.g., text data, media data, etc.) found in the data set. Further, the classification engine 125 may use a classification model that may only include certain classifier for bias categories of interest or a single classifier. Furthermore, the classification model may use other types of classifiers such as logistic regression, clustering, decision trees, neural networks, and/or the like.

According to various aspects, the classification engine 215 may recognize sub-categories found in the different bias categories that are applicable to a data instance as those sub-categories having a prediction (e.g., a prediction value) that satisfies a threshold (e.g., a prediction value of at least 0.75). In addition, the classification engine 215 may consider the confidence of the prediction in addition to the prediction (e.g., whether the confidence value also satisfies a threshold) in determining whether a particular sub-category of a bias category is applicable to a data instance.

In some aspects, the classification engine 215 can pre-process data instances found in the data set to convert the data instances into a format that is more suitable for classification analysis prior to identifying the sub-categories. For instance, the data instances may include text data. Here, the classification engine 215 can pre-process the text data for each data instance to generate one or more embedded representations of the text data. For example, according to some aspects, the classification engine 215 may perform some type of natural language processing, such as word embedding, on the text data to generate the one or more embedded representations of the text data. An embedded representation may comprise a vector representation of the text data having components with numerical values. The embedded representation may serve as one or more context information, characteristics, attributes, and/or the like of the text data. Additionally, or alternatively, the data instances may include media data such as images. The classification engine 215 can generate one or more embedded representations of the media data. For example, according to some aspects, the classification engine 215 may process the media data (e.g., an image) using a convolutional neural network to generate the one or more embedded representations of the media data. Again, an embedded representation may comprise a vector representation of the media data having components with numerical values. The embedded representation may serve as one or more context information, characteristics, attributes, and/or the like of the media data. According to various aspects, the classification engine 215 may perform other types of pre-processing to place the data instances in a more favorable format for classification analysis such as one-hot encoding to generate encoded representations of data, such as categorical data, and/or speech-to-text to convert audio data into text data. According to some aspects, the classification engine 215 may concatenate and/or merge the different representations of a data instance to form a combined representation of the data instance.

The data set analysis module 210 can also analyze the sub-categories found in the different bias categories identified for the data set in Operation 320. For instance, the data set analysis module 210 may analyze the sub-categories found in the different bias categories identified for the data set to determine whether any particular sub-category for a bias category is underrepresented or overrepresented in the data set. For example, the data set analysis module 210 may compare the proportion of the data set (e.g., the number of data instances) associated with a particular sub-category found in a bias category to one or more thresholds to determine whether the proportion of the data set associated with the particular sub-category satisfies either of the thresholds. For instance, a first threshold (e.g., 20%) may be used in determining whether the particular sub-category found in the bias category is underrepresented in the data set and a second threshold (e.g., 80%) may be used in determining whether the particular sub-category found in the bias category is overrepresented in the data set. Accordingly, if the proportion of the data set associated with a particular sub-category found in a bias category satisfies one of the thresholds, then the data set analysis module 210 may determine that the data set may be potentially biased with respect to the particular sub-category found in the bias category.

According to particular aspects, the data set analysis module 210 can refine the analysis of the sub-categories found in the different bias categories identified for the data set based on one or more factors, attributes, characteristics, and/or the like. For instance, according to some aspects, each data instance found in the data set may be assigned an indication of a geographical or jurisdictional location associated with the data instance. For example, a particular data instance in the data set may be assigned an indication that the data instance was collected in the European Union (EU) or in the United States. Therefore, according to these aspects, the data set analysis module 210 can analyze the sub-categories for the different bias categories with respect to the factor, attribute, characteristic, and/or the like (e.g., location) and provide results for each bias category that are broken down by the factor, attribute, characteristic, and/or the like (e.g., location). Other factors, attributes, characteristics, and/or the like (e.g., demographic data) may be used in refining the analysis in combination with, or instead of, location.

For example, the data set analysis module 210 may provide results indicating that the data set reflects a bias with respect to ethnicity sub-category “Asian.” Here, the data set analysis module 210 may determine the particular sub-category is overrepresented in the data set and may provide results that break down the data instances found in the data set that are associated with the particular sub-category by location. Accordingly, the results may show that a significant number of the data instances found in the data set associated with this particular sub-category (e.g., 50 percent of the data instances) are associated with a particular location of the United States (e.g., Pacific coast and/or California). That is to say, the results may indicate the data set is biased with respect to ethnicity for a particular location in the United States, and not for other locations in the United States. Such information may provide an individual who is reviewing the results with further insight to explaining why the data set may reflect the bias.

Once the analysis is completed on the data set, the data set analysis module 210 causes performance of one or more actions based on the results of the analysis in Operation 325. For instance, according to particular aspects, the data set analysis module 210 may generate one or more notifications of the results of the analysis. Here, the notification(s) may involve generating and displaying one or more interfaces to an individual (e.g., the individual who had uploaded the data set) to provide the individual with the results. In other instances, the notification(s) may also, or instead, involve generating and sending one or more electronic communications to individual(s) providing the results of the analysis. Accordingly, the results may include a summary of the analysis and any suitable details regarding the analysis. In addition, the results may indicate any prejudice bias that has been identified for the data set.

Further, according to particular aspects, the results may provide the risks associated with any prejudice bias that has been identified for the data set. Here, the data set analysis module 210 may determine the risks associated with any prejudice bias identified for the data set through the use of a risk determination module 225. As discussed further herein, the risk determination module 225 may determine a risk (e.g., risk value and/or risk score) for each of the prejudice biases identified for the data set based on one or more factors, attributes, characteristics, and/or the like that may influence the risk associated with the use of the data set in training, testing, and/or validating machine-learning models.

According to particular aspects, a suitable computing system, such as the bias evaluation computing system 200 and/or the third-party computing system 235, may modify the data set based on the results. For instance, the results may indicate the data set is biased in that the data set is made up of a number of data instances that results in a sub-category for a particular category being overrepresented in the data set. In this example, a computing system that modifies the data set may remove a number of data instances found in the data set that have been identified as applicable to the sub-category for the particular category. Removal of the data instances could include determining the number of instances to remove from the data set based on the level of overrepresentation of the sub-category found in the data set. For example, the computing system that modifies the data set may remove a percentage and/or number of the data instances based on the level of instances (e.g., percentage and/or number of instances) the sub-category is over the threshold.

Additionally or alternatively, a computing system that modifies the data set (e.g., the bias evaluation computing system 200 and/or the third-party computing system 235) could address the prejudice bias by adding data instances to the data set for a sub-category that is underrepresented in the data set. For instance, the computing system may be provided with a pool of data instances to pull from to add instances to the data set. For example, the entity that has uploaded the data set to the bias evaluation system 200 for analysis may also provide a pool of data instances along with the data set. According to some aspects, the bias evaluation system 200 may also process the data instances in the pool to identify applicable sub-categories for the different bias categories so that they may be used to supplement the data set.

In additional or alternative aspects, the data set analysis module 210 may provide recommendations on modifications that can be made to the data set to address any prejudice bias identified for the data set. Here, the data set analysis module 210 generate and transmit one or more notifications of the recommendations in a similar fashion as the notifications provided on the results of the analysis. For example, the data set analysis module 210 may provide a recommendation based on the risk associated with any prejudice bias that has been identified for the data set satisfying a threshold.

In some aspects, a computing system with access to the data set that has been assessed for prejudice bias can receive the notification. This computing system can be used to modify the dataset based on the notification, where such modifications can occur automatically in responsive to receiving the notification or in a partially automated manner based on one or more inputs received by the computing system following the receipt of the notification.

Furthermore, according to some aspects, the data set analysis module 210 may reevaluate the data set, once modified, to determine whether the prejudice bias has been addressed. Therefore, the data set analysis module may work in a closed loop fashion to address any prejudice bias identified for the data set until the bias has been addressed.

### Model Analysis Module

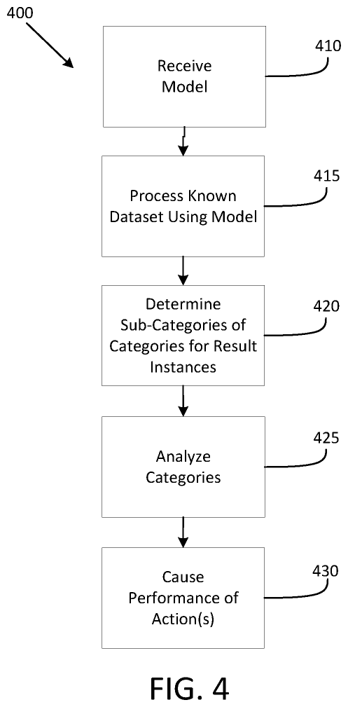

Turning now to FIG. 4, additional details are provided regarding a model analysis module 220 for detecting prejudice bias in a machine-learning model in accordance with various aspects of the disclosure. For instance, the model analysis module 220 is configured according to various aspects for performing the model branch 120 of the bias evaluation process 100. Accordingly, the flow diagram shown in FIG. 4 may correspond to operations carried out, for example, by computing hardware found in the bias evaluation computing system 200 as described herein, as the computing hardware executes the model analysis module 220.

The process 400 involves the model analysis module 220 receiving a machine-learning model for analyzing in Operation 410. As previously mentioned, the bias evaluation system 200 according to particular aspects may provide some type of mechanism such as an application programming interface (API), a Web portal, a user interface, and/or the like that can be used by an individual (e.g., a developer) to facilitate the uploading of the machine-learning model into the system 200.

For instance, the machine-learning model uploaded to the bias evaluation system 200 may be used in an AI application that provides information to individuals on available insurance products provided by a particular insurance provider based on answers to questions presented to the individuals in an audio format. For example, the AI application may entail a software application provided through a kiosk found in a shopping area that shoppers can interact with to learn about the different insurance products offered by the insurance provider. Here, the software application may solicit information from an individual shopper by audibly asking the shopper a series of questions and receiving verbal answers accordingly. The software application may use one or more machine-learning models in processing the shopper's answers and providing information on applicable insurance products that are available through the insurance provider. For example, the software application may use a first machine-learning model to interpret the answers received from the shopper. In addition, the software application may use a second machine-learning model in addition, or instead, to identify (e.g., predict) insurance products that may be of interest to the shopper based on the shopper's answers. Here, some of the information solicited from the shopper through the questions may entail information that may be considered personal in nature. For example, the AI application may request the shopper to identify his or her gender, age, home address, and/or the like. Accordingly, the insurance provider may be interested in evaluating the first or second machine-learning model to determine whether the model may be generating output that reflects prejudice bias. Therefore, the insurance provider (employee thereof) may upload the model to the bias evaluation system 200.

Once uploaded, the model analysis module 220 may be invoked and receives the machine-learning model accordingly. The model analysis module 220 then processes a known data set using the uploaded machine-learning model in Operation 415. In some instances, the entity associated with the machine-learning model may process the known data set, themselves, using the known data set and provide the output instead of uploading the model. Therefore, in these instances, the model analysis module 220 may not need to perform this operations. As previously mentioned, a known data set includes data instances that are known to have data (e.g., personal data) that is associated with certain bias categories (e.g., religion, sexual orientation, age, ethnicity, gender, location, political opinions, and/or the like). Here, the known data set can include proportional data (e.g., a proportional number of data instances) that sufficiently represents each sub-category of the different categories so as to not introduce bias into the output produced by the machine-learning model. For example, the known data set includes data instances where demographics are represented in the same proportions as the wider population that the data set is intended to represent. Therefore, any bias introduced into the output of the machine-learning model is the result of the model itself.

Next, the model analysis module 220 analyzes the results generated from processing the known data set using the uploaded machine-learning model to determine the sub-categories of the different bias categories represented in the result instances found in the results in Operation 420. A “result instance” can be viewed as a data instance found in the known data set and the instance's corresponding output produced by processing the data instance using the machine-learning model. For example, a result instance may represent the answers to one or more questions asked of a shopper who is using the AI application mentioned above that are processed by the second machine-learning model and the one or more insurance products generated as output by the second machine-learning model. According to particular aspects, the model analysis module 220 performs this particular operation by using the classification engine 215 previously described to analyze and assign one or more sub-categories of the different bias categories to result instances. The classification engine 215 can use the classification model to generate a prediction of applicability for each of the sub-categories of the different bias categories in a similar fashion as described above with respect to the data set analysis module 210. In one example, the classification engine 215 uses the output generated by the uploaded machine learning model (e.g., a third-party machine learning model being assessed) as input provided to the classification model. In another example, the classification engine 215 combines the output generated by the uploaded machine learning model and corresponding data instances from the known data set to form result instances, and uses the set of result instances used as input the classification model. In another example, the classification engine 215 combines the output generated by the uploaded machine learning model with other data usable for identifying the bias categories from the known data set that are associated with the output, and uses this set of result instances used as input to the classification model. As previously mentioned, the classification engine 215 according to various aspects may recognize the sub-categories of the bias categories that are applicable to an output instance as those sub-categories having a prediction (e.g., prediction value) that satisfies a threshold (e.g., a prediction value of at least 0.75). In addition, the classification engine 215 may consider the confidence of the prediction (e.g., whether the confidence value also satisfies a threshold) in determining whether a particular sub-category found in a bias category is applicable to an output instance.

The model analysis module 220 then analyzes the sub-categories found in the bias categories identified for the results to determine whether any of the bias categories are significantly impacting the output found in the results in Operation 425. For example, similar to analyzing a data set, a determination may be made as to whether a proportion of the results (e.g., number of result instances) that represents a sub-category for any particular category satisfies a threshold amount or percentage of the part of the results (e.g., total number of result instances) that represents the particular category. Therefore, similar to the data set analysis module 210, the model analysis module 220 may analyze the sub-categories found in the different bias categories identified for the results to determine whether any particular sub-category found in a bias category is underrepresented or overrepresented in the results. Again, the model analysis module 220 may analyze each of the sub-categories of the different bias categories by comparing the proportion of the results (e.g., the number of result instances) associated with the sub-category to one or more thresholds to determine whether the proportion of the results associated with the sub-category satisfies either of the thresholds.

According to other aspects, the model analysis module 220 may determine whether the machine-learning model is generating erroneous output for the known data set that amounts to the model having a prejudice bias. For example, corresponding (correct) sub-categories may be identified for each of the data instances found in the known data set and the model analysis module 220 may identify the data instances that were processed using the machine-learning model and produced outputs having false indications for a particular sub-category found in the bias category. For example, the known data set may include images as data instances in which each image is associated with the sub-category of male or female. In this example, the model analysis module 220 may identify those images found in the known data set in which the image is associated with one gender (e.g., female) and the machine-learning model generated an output associated with the other gender (e.g., male). According to some aspects, the model analysis module 220 may determine whether the machine-learning model has produced erroneous outputs for a particular sub-category found in a bias category that satisfies a threshold. If so, then the model analysis module 220 may identify the machine-learning model as having a prejudice bias with respect to the particular sub-category.

According to particular aspects, the model analysis module 220 can refine the analysis of the bias categories identified for the results based on one or more factors, attributes, characteristics, and/or the like. For instance, according to some aspects, each output instance found in the output may be assigned an indication of a geographical or jurisdictional location associated with the data instance. For example, a particular data instance provided in the known data set may be assigned an indication that the data instance was collected in the European Union (EU) or in the United States. The corresponding output generated by the machine-learning model by processing the particular data instance may be associated with the indication of the geographical or jurisdictional location. In an illustrative example, the machine-learning model being assessed for prejudice could be used to assess a risk level for certain consumers (e.g., in an insurance context). The model analysis module 220 could assess risk levels outputted by the machine-learning model and initially determine that certain outputs (e.g., assessment of higher risk) are skewed toward a certain bias category (e.g., age). The model analysis module 220 could refine this initial determination based on a geographical or jurisdictional location, such as by determining that assessments of higher risk skewed toward a certain age group would be accurate with respect to the population in one region even if those skewed results are inaccurate (i.e., unfairly discriminatory) with respect to a population in a different region.

Therefore, the model analysis module 220 can analyze the different bias categories with respect to the factor, attribute, characteristic, and/or the like (e.g., location) and provide results for each bias category that are broken down by the factor, attribute, characteristic, and/or the like (e.g., location).

The model analysis module 220 causes performance of one or more actions based on the results of the analysis performed on the machine-learning model in Operation 430. For instance, according to particular aspects, the model analysis module 220 may generate one or more notifications providing the results of the analysis. For example, the notification(s) may involve generating and displaying one or more interfaces to an individual (e.g., the individual who had uploaded the machine-learning model) to provide the individual with the results. In other instances, the notification(s) may also, or instead, involve generating and sending one or more electronic communications to individual(s) providing the results of the analysis. Accordingly, the results may include a summary of the analysis and any suitable details regarding the analysis. In addition, the results may indicate any prejudice bias identified for the machine-learning model. Further, according to some aspects, the results may provide the risks associated with any prejudice bias identified for the machine-learning model. Similar to the data set analysis module 210, the model analysis module 220 may determine the risk associated with any prejudice bias identified for the machine-learning model through the use of a risk determination module 225. Further, the model analysis module 220 may provide a recommendation based on the risk satisfying a threshold.

According to particular aspects, a suitable computing system, such as the bias evaluation computing system 200 and/or the third-party computing system 235, may provide one or more analytic techniques, processes, tools, and/or the like that can be used in identifying what components of a machine-learning model are generating (e.g., activating) a resulting output indicating prejudice bias such as, for example, the algorithm (e.g., type of model), input variables, weights, activation function, loss function, number of hidden layers, and/or the like. For example, according to particular aspects, the suitable computing system may provide an individual with one or more interfaces to one or more analytical tools, such as the Language Interpretability Tool (LIT) and/or What-If-Tool (WIT) provided by Google, that can used in determining whether a machine-learning model is inherently biased. In another example, many machine-learning models generate one or more configuration files. According to particular aspects, the suitable computing system may provide individuals with one or more analytical tools for analyzing the configuration file(s) of a machine-learning model to provide further information that can be used in determining whether the model is inherently bias. Therefore, according to some aspects, the one or more actions performed by the model analysis module 220 may involve providing one or more interfaces to such tools, along with the results of the analysis, to an individual who can then use the tools in further analyzing the machine-learning model.

In some aspects, a computing system with access to the machine-learning model that has been assessed for prejudice bias can receive a notification on the results of the analysis. For example, the computing system may receive a notification that the machine-learning model has a prejudice bias and in response, this computing system can be used to take action based on the notification such as have the machine-learning model removed (suspended) from being used in applications. Such action can occur automatically in responsive to receiving the notification or in a partially automated manner based on one or more inputs received by the computing system following the receipt of the notification.

### Risk Determination Module

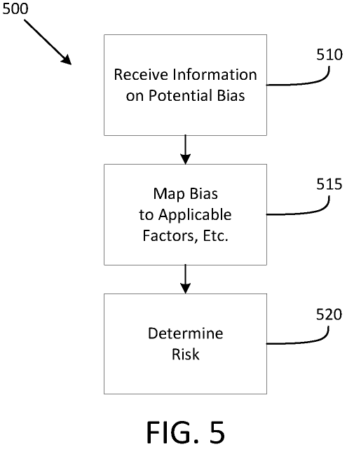

Turning now to FIG. 5, additional details are provided regarding a risk determination module 225 for determining a risk associated with a prejudice bias identified for a data set or a machine-learning model in accordance with various aspects of the disclosure. As previously noted, according to various aspects, the risk determination module 225 may be invoked by the data set analysis module 210 and/or the model analysis module 220 to determine a risk associated with a prejudice bias identified for a data set or a machine-learning model. Accordingly, the flow diagram shown in FIG. 5 may correspond to operations carried out, for example, by computing hardware found in the bias evaluation computing system 200 as described herein, as the computing hardware executes the risk determination module 225.

As noted, the risk associated with a prejudice bias identified for a data set may be based on one or more factors, attributes, characteristics, and/or the like that may influence the risk with using the data set in training, testing, and/or validating a machine-learning model. Likewise, the risk associated with a prejudice bias identified for a machine-learning model may be based on one or more factors, attributes, characteristics, and/or the like that may influence the risk with using the machine-learning model for some type of application (e.g., AI application). Therefore, in many instances, the risk associated with a prejudice bias may be dependent on the machine-learning model that is produced from a biased data set, that can lead to a biased machine-learning model, as well as the applications in which a biased machine-learning model is used.

For instance, in an increasing number of jurisdictions around the globe, the use of AI that may exhibit prejudice bias with respect to different races, genders, backgrounds, cultures, and/or the like may violate one or more laws or regulations put in place addressing privacy and/or the use of individual's personal and/or sensitive data. For example, laws and/or regulations associated with the handling of personal and/or sensitive data of individuals may include bias-related compliance requirements. Violations of the requirements may occur regardless of whether such bias was the result of human activity, automated computing activity, or any combination thereof. Therefore, an entity operating AI applications in a jurisdiction in which bias-related requirements are applicable may wish to be aware of any prejudice bias that may be generated by any machine learning used within its AI applications.

Turning now to FIG. 5, the process 500 involves the risk determination module 225 receiving information on a prejudice bias identified for a data set and/or machine-learning model in Operation 510. For example, the risk determination module 225 may have been invoked by the data set analysis module 210 or the model analysis module 220, which in turn provides the risk determination module 225 with information on a prejudice bias identified for a data set or machine-learning model. Accordingly, the information may identity the prejudice bias along with a summary of the analysis conducted in identifying the prejudice bias and/or any suitable details regarding the analysis. In addition, the information may include one or more factors, attributes, characteristics, and/or the like that may be used in identifying the risks. For example, the information may include one or more locations associated with the prejudice bias. As previously noted, according to particular aspects, the data instances within a data set being analyzed and/or output instances found in the output generated by a machine-learning model being analyzed may include an indication of an associated location. Therefore, the location(s) identified for the data instances and/or output instances associated with the prejudice bias may be provided in the information received by the risk determination module.

The risk determination module 225 then maps the prejudice bias to any applicable factors, attributes, characteristics, and/or the like that may influence the risk in Operation 515. For instance, returning to the example in which one or more regulations, law, standards, and/or the like may have one or more bias-related compliance requirements that are applicable to the use of a machine-learning model that has been trained, tested, and/or validated using a biased data set and/or a biased machine-learning model, itself, the risk determination module may map the location(s) associated with the prejudice bias to the bias-related compliance requirements for the applicable regulations, standards, and/or the like.

Once mapped to the applicable factors, attributes, characteristics, and/or the like, the risk determination module 225 determines the risk associated with the prejudice bias in Operation 520. For example, the risk determination module 225 may determine the risk (e.g., a risk level and/or score) for the prejudice bias based on one or more fines and/or penalties associated with not complying with the bias-related compliance requirements. Those of ordinary skill in the art can envision other criteria that may be used in determining a risk associated with a prejudice bias in light of this disclosure.

### Other Aspects of the System

It is noted that according to particular aspects of the bias evaluation system 200, rather than analyze every data instance found in a particular data set, the analysis may be carried out by sampling the data set and analyzing a subset of the data instances found in the data set. This may improve the efficiency of the analysis, especially in instances in which the data set is quite large.

In addition, according to particular aspects, the thresholds, and/or any other data, used to determine whether the analysis of a data set (or sampled data set) and/or machine-learning model indicates prejudice bias may be based, at least in part, on one or more regulations, laws, standards, requirements, and/or the like. For example, such thresholds and/or any other data used to determine whether the analysis of a data set and/or machine-learning model indicates prejudice bias may also, or instead, be based, at least in part, on one or more fines or other penalties associated with such regulations, laws, standards, requirements, and/or the like. According to particular aspects, the bias evaluation system 200 may retrieve such information from a data repository that stores legal requirements and penalties from across the globe and/or requirements and penalties associated with one or more standards bodies.

### Example Technical Platforms

Aspects of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example aspects, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

According to various aspects, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

According to various aspects, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where various aspects are described to use a computer-readable storage medium, other types of computer-readable storage media may be substituted for or used in addition to the computer-readable storage media described above.

Various aspects of the present disclosure may also be implemented as methods, apparatuses, systems, computing devices, computing entities, and/or the like. As such, various aspects of the present disclosure may take the form of a data structure, apparatus, system, computing device, computing entity, and/or the like executing instructions stored on a computer-readable storage medium to perform certain steps or operations. Thus, various aspects of the present disclosure also may take the form of entirely hardware, entirely computer program product, and/or a combination of computer program product and hardware performing certain steps or operations.

Various aspects of the present disclosure are described below with reference to block diagrams and flowchart illustrations. Thus, each block of the block diagrams and flowchart illustrations may be implemented in the form of a computer program product, an entirely hardware aspect, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example of aspects, retrieval, loading, and/or execution may be performed in parallel such that multiple instructions are retrieved, loaded, and/or executed together. Thus, such aspects can produce specially configured machines performing the steps or operations specified in the block diagrams and flowchart illustrations. Accordingly, the block diagrams and flowchart illustrations support various combinations of aspects for performing the specified instructions, operations, or steps.

### Example System Architecture

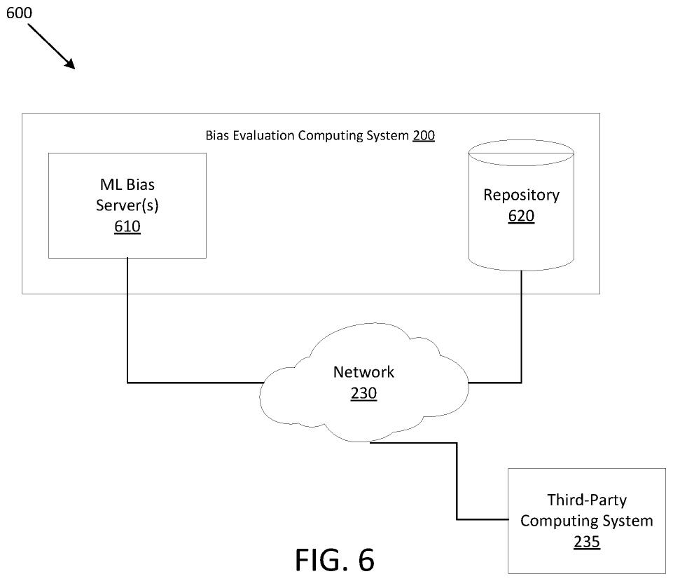

FIG. 6 is a block diagram of a system architecture 600 that can be used in implementing the bias evaluation process 100 according to various aspects of the disclosure as detailed herein. Accordingly, entities of the system architecture 600 are configured according to various aspects to analyze machine-learning models and/or data sets used for training, testing, and/or validating the machine-learning models for prejudice bias. For example, the machine-learning models and/or data sets that are to be analyzed may be created, developed, maintained, used, and/or the like by one or more third-party developers, may be provided by one or more AI application provider servers or other systems, and/or may be installed on one or more remote systems for use.

As may be understood from FIG. 6, the system architecture 600 according to various aspects may include a bias evaluation computing system 200 that comprises one or more machine-learning bias servers (ML bias servers) 610 and one or more repositories 620. Although the ML bias server(s) 610 and repositor(ies) 620 are shown as separate entities, it should be understood that according to other aspects, these entities 610, 620 may comprise a single server and/or repository, a plurality of servers and/or repositories, one or more cloud-based servers and/or repositories, or any other suitable configuration.

The ML bias server(s) 610 may acquire a data set and/or machine-learning model that is uploaded over a network 230 from a remote third-party computing system 235 and may execute a data set analysis module 210, model analysis module 220, and/or risk determination module 225 as described herein to analyze the data set and/or machine-learning model and to identify any prejudice bias that may be associated with the data set and/or machine-learning model, and/or determine a risk associated with an identified prejudice bias for a data set and/or machine-learning model. Accordingly, the repository server(s) 620 can store information (e.g., results) generated by the analysis conducted on the machine-learning model and/or data set. In addition, the repository server(s) 620 may be used according to various aspects for storing other information used in conducting the analysis on the machine-learning model and/or the data set such as, for example, information on legal requirements and penalties from across the globe and/or requirements and penalties associated with one or more standards bodies.

In addition, according to particular aspects, the ML bias server(s) 610 are configured to provide one or more interfaces (e.g., APIs, Web portals, websites, direct connections, and/or the like) through which a data set and/or machine-learning model may be updated, as well as one or more interfaces (e.g., websites, transfer protocol interfaces, and/or the like) for displaying and/or communicating results of analysis conducted on a data set and/or machine-learning model. Furthermore, according to particular aspects, the ML bias server(s) 610 are configured to provide analytical tools that may be accessed by individuals who are conducting further analysis on data sets and/or machine-learning models. Accordingly, the ML bias server(s) 610 and/or repository server(s) 620 may interface with the third-party computing system(s) 235 via one or more suitable application programming interfaces (APIs), direct connections, and/or the like.

### Example Computing Hardware

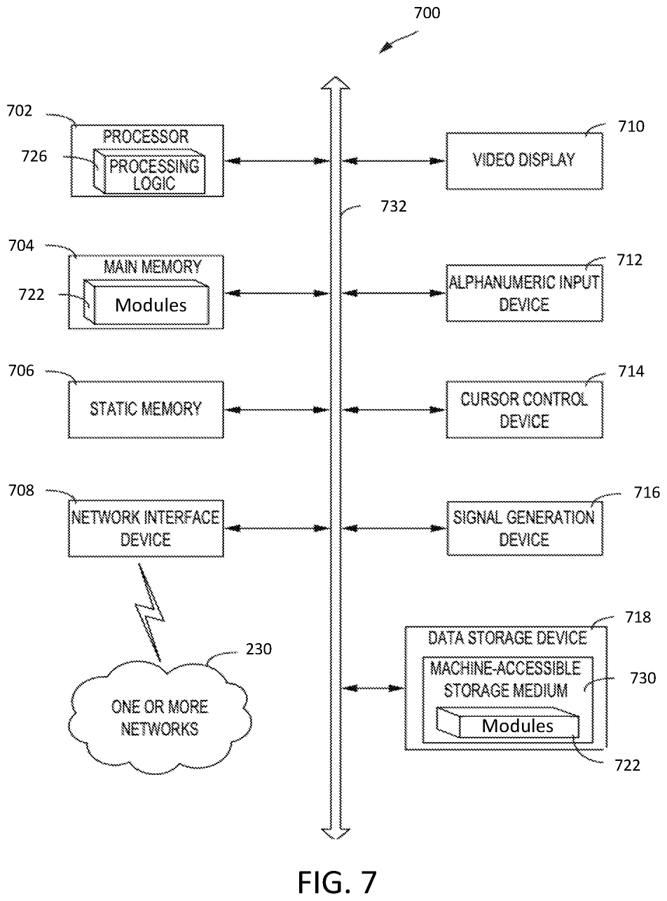

FIG. 7 illustrates a diagrammatic representation of a computing hardware device 700 that may be used in accordance with various aspects of the disclosure. For example, the hardware device 700 may be computing hardware such as a server 610 as described in FIG. 6. According to particular aspects, the hardware device 700 may be connected (e.g., networked) to one or more other computing entities, storage devices, and/or the like via one or more networks such as, for example, a LAN, an intranet, an extranet, and/or the Internet. As noted above, the hardware device 700 may operate in the capacity of a server and/or a client device in a client-server network environment, or as a peer computing device in a peer-to-peer (or distributed) network environment. According to various aspects, the hardware device 700 may be a personal computer (PC), a tablet PC, a set-top box (STB), a Personal Digital Assistant (PDA), a mobile device (smartphone), a web appliance, a server, a network router, a switch or bridge, or any other device capable of executing a set of instructions (sequential or otherwise) that specify actions to be taken by that device. Further, while only a single hardware device 700 is illustrated, the term “hardware device,” “computing hardware,” and/or the like shall also be taken to include any collection of computing entities that individually or jointly execute a set (or multiple sets) of instructions to perform any one or more of the methodologies discussed herein.

A hardware device 700 includes a processor 702, a main memory 704 (e.g., read-only memory (ROM), flash memory, dynamic random-access memory (DRAM) such as synchronous DRAM (SDRAM), Rambus DRAM (RDRAM), and/or the like), a static memory 706 (e.g., flash memory, static random-access memory (SRAM), and/or the like), and a data storage device 718, that communicate with each other via a bus 732.

The processor 702 may represent one or more general-purpose processing devices such as a microprocessor, a central processing unit, and/or the like. According to some aspects, the processor 702 may be a complex instruction set computing (CISC) microprocessor, reduced instruction set computing (RISC) microprocessor, very long instruction word (VLIW) microprocessor, a processor implementing other instruction sets, processors implementing a combination of instruction sets, and/or the like. According to some aspects, the processor 702 may be one or more special-purpose processing devices such as an application specific integrated circuit (ASIC), a field programmable gate array (FPGA), a digital signal processor (DSP), network processor, and/or the like. The processor 702 can execute processing logic 726 for performing various operations and/or steps described herein.

The hardware device 700 may further include a network interface device 708, as well as a video display unit 710 (e.g., a liquid crystal display (LCD), a cathode ray tube (CRT), and/or the like), an alphanumeric input device 712 (e.g., a keyboard), a cursor control device 714 (e.g., a mouse, a trackpad), and/or a signal generation device 716 (e.g., a speaker). The hardware device 700 may further include a data storage device 718. The data storage device 718 may include a non-transitory computer-readable storage medium 730 (also known as a non-transitory computer-readable storage medium or a non-transitory computer-readable medium) on which is stored one or more modules 722 (e.g., sets of software instructions) embodying any one or more of the methodologies or functions described herein. For instance, according to particular aspects, the modules 722 include a data set analysis module 210, a model analysis module 220, and/or a risk determination module 225 as described herein. The one or more modules 722 may also reside, completely or at least partially, within main memory 704 and/or within the processor 702 during execution thereof by the hardware device 700-main memory 704 and processor 702 also constituting computer-accessible storage media. The one or more modules 722 may further be transmitted or received over a network 230 via the network interface device 708.

While the computer-readable storage medium 730 is shown to be a single medium, the terms “computer-readable storage medium” and “machine-accessible storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding, and/or carrying a set of instructions for execution by the hardware device 700 and that causes the hardware device 700 to perform any one or more of the methodologies of the present disclosure. The term “computer-readable storage medium” should accordingly be understood to include, but not be limited to, solid-state memories, optical and magnetic media, and/or the like.

### System Operation

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, steps, structural devices, acts, or modules. These states, operations, steps, structural devices, acts, and modules may be implemented in software, in firmware, in special purpose digital logic, and any combination thereof. Greater or fewer operations may be performed than shown in the figures and described herein. These operations also may be performed in a different order than those described herein.

### CONCLUSION

While this specification contains many specific aspect details, these should not be construed as limitations on the scope of any invention or of what may be claimed, but rather as descriptions of features that may be specific to particular aspects of particular inventions. Certain features that are described in this specification in the context of separate aspects also may be implemented in combination in a single aspect. Conversely, various features that are described in the context of a single aspect also may be implemented in multiple aspects separately or in any suitable sub-combination. Moreover, although features may be described above as acting in certain combinations and even initially claimed as such, one or more features from a claimed combination may in some cases be excised from the combination, and the claimed combination may be a sub-combination or variation of a sub-combination.

Similarly, while operations are described in a particular order, this should not be understood as requiring that such operations be performed in the particular order described or in sequential order, or that all described operations be performed, to achieve desirable results. In certain circumstances, multitasking and parallel processing may be advantageous. Moreover, the separation of various components in the various aspects described above should not be understood as requiring such separation in all aspects, and the described program components (e.g., modules) and systems may generally be integrated together in a single software product or packaged into multiple software products.

Many modifications and other aspects of the disclosure will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for the purposes of limitation.

What is claimed is:

1. A method comprising:
generating a plurality of outputs by processing a known data set using a machine-learning model, wherein the known data set comprises a plurality of data instances associated with a plurality of sub-categories for each bias category in a plurality of bias categories;
generating a plurality of result instances comprising combinations of the plurality of data instances and the plurality of outputs;
generating, by computing hardware utilizing a classification model to process result instances of the plurality of result instances, a prediction of applicability for each sub-category of the plurality of sub-categories for each bias category of the plurality of bias categories;
determining, by the computing hardware and according to a plurality of predictions generated using the classification model, that a particular sub-category of the plurality of sub-categories for a particular bias category of the plurality of bias categories is applicable to a proportion of the plurality of result instances;
comparing the proportion of the plurality of result instances in the particular sub-category of the particular bias category to a threshold percentage of a data set representing the particular bias category; and
determining, by the computing hardware, that the machine-learning model has a prejudice bias with respect to the particular bias category in response to determining that the proportion of the plurality of result instances in the particular sub-category satisfies the threshold percentage of the data set representing the particular bias category.

2. The method of claim 1, further comprising causing, by the computing hardware, a computing system to:
generate a modified data set by adding data instances for one or more of the plurality of bias categories based on the prejudice bias to the known data set; and
re-train the machine-learning model using the modified data set to operate in a less biased manner for an artificial intelligence application.

3. The method of claim 2, wherein generating the modified data set comprises:
determining applicable sub-categories of the plurality of bias categories for a pool of data instances;
adding data instances for an underrepresented sub-category of the plurality of bias categories based on the prejudice bias from the pool of data instances to the known data set; and
removing a plurality of data instances applicable to the particular sub-category.

4. The method of claim 3, further comprising:
generating, by computing hardware and with the classification model, a prediction of applicability for each sub-category of the plurality of sub-categories for each bias category of the plurality of bias categories for each data instance of a plurality of data instances found in the modified data set; and
determining, by the computing hardware based on the prediction of applicability generated for each sub-category of the plurality of sub-categories for each bias category of the plurality of bias categories for each data instance, that the modified data set does not have a prejudice bias.

5. The method of claim 1, wherein:
the classification model comprises an ensemble comprising a multi-label classifier for each bias category of the plurality of bias categories, wherein the plurality of bias categories comprises one or more of religion, sexual orientation, age, ethnicity, gender, location, or political opinions, and
each multi-label classifier is configured to generate the prediction of applicability by generating a probability that each sub-category of the plurality of sub-categories for a corresponding bias category of the plurality of bias categories applies to a combination of the data instance and a corresponding output of the machine-learning model.

6. The method of claim 1, wherein generating the modified data set comprises:
processing a pool of data instances to identify data instances corresponding to a sub-category that is underrepresented in the known data set; and
adding the data instances correspond to the sub-category that is underrepresented in the known data set to the known data set.

7. The method of claim 1, wherein the method further comprises:
mapping, by the computing hardware, the prejudice bias to a factor influencing a risk associated with the machine-learning model having the prejudice bias; and
determining, by the computing hardware based on the factor, the risk associated with the machine-learning model having the prejudice bias.

8. The method of claim 1, wherein the method further comprises:
analyzing the particular bias category with respect to a location; and
determining that the machine-learning model does not have the prejudice bias with respect to the particular bias category in the location.

9. A system comprising:
a non-transitory computer-readable medium storing instructions; and
a processing device communicatively coupled to the non-transitory computer-readable medium,
wherein, the processing device is configured to execute the instructions and thereby perform operations comprising:
generating a plurality of outputs by processing a known data set using a machine-learning model, wherein the known data set comprises a plurality of data instances associated with a plurality of sub-categories for each bias category in a plurality of bias categories;
generating a plurality of result instances comprising combinations of the plurality of data instances and the plurality of outputs;
generating, by computing hardware utilizing a classification model to process result instances of the plurality of result instances, a prediction of applicability for each sub-category of the plurality of sub-categories for each bias category of the plurality of bias categories;
determining, by the computing hardware and according to a plurality of predictions generated using the classification model, that a particular sub-category of the plurality of sub-categories for a particular bias category of the plurality of bias categories is applicable to a proportion of the plurality of result instances;
comparing the proportion of the plurality of result instances in the particular sub-category of the particular bias category to a threshold percentage of a data set representing the particular bias category; and
determining, by the computing hardware, that the machine-learning model has a prejudice bias with respect to the particular bias category in response to determining that the proportion of the plurality of result instances in the particular sub-category satisfies the threshold percentage of the data set representing the particular bias category.

10. The system of claim 9, wherein the operations further comprise:
generating a modified data set by adding data instances for one or more of the plurality of bias categories based on the prejudice bias to the known data set; and
re-training the machine-learning model using the modified data set to operate in a less biased manner for an artificial intelligence application.

11. The system of claim 9, wherein the operations further comprise providing an interface to an analytics tool used in identifying a component of the machine-learning model influencing the machine-learning model having the prejudice bias.

12. The system of claim 9, wherein determining that the machine-learning model has the prejudice bias comprises at least one of determining the proportion of the plurality of result instances is less than the threshold percentage and the prejudice bias indicates the particular sub-category is underrepresented in the plurality of result instances or determining the proportion of the plurality of result instances is greater than the threshold percentage and the prejudice bias indicates the particular sub-category is overrepresented in the plurality of result instances.

13. The system of claim 9, wherein determining that the machine-learning model has the prejudice bias involves determining that the proportion of the plurality of result instances comprises a number of result instances that are falsely applicable to the particular sub-category satisfies the threshold percentage.

14. The system of claim 9, wherein the operations further comprise processing one or more data instances of a pool of data instances to identify applicable sub-categories, wherein generating the modified data set is based on processing the one or more data instances of the pool of data instances.

15. The system of claim 9, wherein the operations further comprise:
mapping the prejudice bias to a factor influencing a risk associated with the machine-learning model having the prejudice bias; and
determining, based on the factor, the risk associated with the machine-learning model having the prejudice bias.

16. A computing system comprising:
first computing hardware configured for:
generating a plurality of outputs by processing a known data set using a machine-learning model, wherein the known data set comprises a plurality of data instances associated with a plurality of sub-categories for each bias category in a plurality of bias categories;
generating a plurality of result instances comprising combinations of the plurality of data instances and the plurality of outputs;
generating, by computing hardware utilizing a classification model to process result instances of the plurality of result instances, a prediction of applicability for each sub-category of the plurality of sub-categories for each bias category of the plurality of bias categories;
determining, by the computing hardware and according to a plurality of predictions generated using the classification model, that a particular sub-category of the plurality of sub-categories for a particular bias category of the plurality of bias categories is applicable to a proportion of the plurality of result instances;
comparing the proportion of the plurality of result instances in the particular sub-category of the particular bias category to a threshold percentage of a data set representing the particular bias category; and
determining, by the computing hardware, that the machine-learning model has a prejudice bias with respect to the particular bias category in response to determining that the proportion of the plurality of result instances in the particular sub-category satisfies the threshold percentage of the data set representing the particular bias category.

17. The computing system of claim 16, further comprising second computing hardware communicatively coupled to the first computing hardware, the second computing hardware configured for:
generating a modified data set by adding data instances for one or more of the plurality of bias categories to the known data set; and
re-training a machine-learning model using the modified data set to operate in a less biased manner for an artificial intelligence application.

18. The computing system of claim 16, wherein the first computing hardware is further configured for suspending the machine-learning model from being used in an artificial intelligence application based on determining that the machine-learning model has the prejudice bias with respect to the particular bias category.

19. The computing system of claim 16, wherein:
the classification model comprises an ensemble comprising a multi-label classifier for each bias category of the plurality of bias categories, wherein the plurality of bias categories comprises one or more of religion, sexual orientation, age, ethnicity, gender, location, or political opinions, and
each multi-label classifier is configured to generate the prediction of applicability by generating a probability that each sub-category of the plurality of sub-categories for a corresponding bias category of the plurality of bias categories applies to a combination of a data instance and a corresponding output of the machine-learning model.

20. The computing system of claim 16, wherein the proportion of the plurality of result instances is associated with a location and the first computing hardware is further configured for:
mapping, based on the location, the prejudice bias to a factor influencing a risk associated with the machine-learning model having the prejudice bias; and
determining, based on the factor, the risk associated with the machine-learning model having the prejudice bias.
